(19) United States
(12) Patent Application Publication
(10) Pub. No.: US 2025/0157770 A1
(43) Pub. Date: May 15, 2025

(54) BREAKER ASSEMBLY

(71) Applicant: Dongguan Littelfuse Electronics Company Limited, Dongguan City (CN)

(72) Inventors: Kevin Liang, Dongguan City (CN); Bing Wang, Dongguan City (CN); Tao Guo, Dongguan City (CN)

(73) Assignee: Dongguan Littelfuse Electronics Company Limited, Dongguan City, GD (CN)

(21) Appl. No.: 18/838,676

(22) PCT Filed: Feb. 16, 2023
(86) PCT No.: PCT/IB2023/051426

§ 371 Date: Aug. 15, 2024

(30) Foreign Application Priority Data
Feb. 18, 2022 (CN) 202210152913.X

(51) Int. Cl. H01H 71/08; H01H 71/02; H01M 50/581; H02K 11/25

(52) U.S. Cl. CPC H01H 71/08; H01H 71/02; H01M 50/581; H02K 11/25

(57) ABSTRACT

A breaker assembly features a housing. a mini-breaker, a first terminal, and a second terminal. The mini-breaker includes a third terminal and a fourth terminal. The first terminal has a first lead that is connected to the fourth terminal once the first terminal is placed in the housing. The second terminal has a second lead that is disposed over the third terminal once the second terminal is placed in the housing.

### CROSS REFERENCE TO RELATED APPLICATION

This application claims the benefit of priority to, Chinese Patent Application No. 202210152913.X, filed Feb. 18, 2022, entitled “BREAKER ASSEMBLY,” which application is incorporated herein by reference in its entirety.

### FIELD OF THE DISCLOSURE

Embodiments of the present disclosure relate to thermal cutoff devices, and, more particularly, to the expanded use of thermal cutoff devices.

### BACKGROUND

Thermal cutoff devices are used with batteries to protect against overheating. Lithium Ion Polymer and Prismatic batteries are found in a host of mobile electronic devices, such as laptop PCs, tablets, and smart phones. One type of thermal cutoff device, a metal hybrid breaker, known also as a mini-breaker, features a bimetallic switch disposed in parallel with a polymeric positive temperature coefficient (PPTC) device, with the metal hybrid breaker being attached to the battery. Once the battery begins to overheat, the bimetallic switch opens up, causing current to instead pass through the PPTC device. Additionally, the PPTC device acts as a heater to keep the bimetal switch latched until the battery cools down again. The mini-breaker thus provides resettable overtemperature protection for the battery.

The metal hybrid breaker is limited to lead attached applications, such as the batteries found in mobile devices. Further, the metal hybrid breaker is designed to protect against temperatures below 100° C. The mini-breaker is thus not suitable for environments in which the temperature gets higher than 100° C.

It is with respect to these and other considerations that the present improvements may be useful.

### SUMMARY

This Summary is provided to introduce a selection of concepts in a simplified form that are further described below in the Detailed Description. This Summary is not intended to identify key or essential features of the claimed subject matter, nor is it intended as an aid in determining the scope of the claimed subject matter.

An exemplary embodiment of a breaker assembly in accordance with the present disclosure may include a housing, a mini-breaker, a first terminal, and a second terminal. The mini-breaker includes a third terminal and a fourth terminal. The first terminal has a first lead that is connected to the fourth terminal once the first terminal is placed in the housing. The second terminal has a second lead that is disposed over the third terminal once the second terminal is placed in the housing.

Another exemplary embodiment of a breaker assembly in accordance with the present disclosure may include a printed circuit board, a mini-breaker, a first terminal, and a second terminal. The printed circuit board has a first trace, a second trace, and an opening, where the first trace is longer than the second trace. The mini-breaker has a third terminal, a fourth terminal, and a housing. The housing fits into the opening, the third terminal sits on the first trace, and the fourth terminal sits on the second trace. The first terminal is coupled to the first trace and the second terminal is coupled to the second trace.

### BRIEF DESCRIPTION OF THE DRAWINGS

FIGS. 1A-1B are diagrams illustrating a breaker assembly, in accordance with exemplary embodiments;

FIGS. 2A-2B are circuit diagrams of a mini-breaker used in the breaker assembly of FIGS. 1A-1B, in accordance with exemplary embodiments;

FIGS. 3A-3C are diagrams of breaker assemblies, in accordance with exemplary embodiments;

FIGS. 4A-4D are diagrams of the construction of the breaker assembly of FIG. 3A, in accordance with exemplary embodiments;

FIGS. 5A-SE are diagrams of the construction of the breaker assemblies of FIGS. 3B and 3C, in accordance with exemplary embodiments; and

FIG. 6 is a diagram illustrating a vehicle motor with a breaker assembly, in accordance with exemplary embodiments.

### DETAILED DESCRIPTION

A breaker assembly is disclosed which utilizes a modified version of a mini-breaker, where the mini-breaker consists of a bimetallic switch and a PPTC device disposed in parallel with one another. The mini-breaker is modified to provide protection to electronic devices that reach up to 120° C. One embodiment of the breaker assembly features a lead extender and two terminals that fit snugly into a housing, with the lead extender providing a mechanism for one terminal to “reach” a terminal of the mini-breaker. The housing includes openings and ledges strategically placed to support the contents of the breaker assembly. Second and third embodiments of breaker assemblies feature a printed circuit board with traces arranged to enable two terminals of the breaker assembly to connect with two terminals of the mini-breaker. Instead of a housing, the second embodiment features a shrink-wrap covering and the third embodiment features a coating covering. The three embodiments can protect electronic devices, such as a vehicle motor.

For the sake of convenience and clarity, terms such as “top”, “bottom”, “upper”, “lower”, “vertical”, “horizontal”, “lateral”, “transverse”, “radial”, “inner”, “outer”, “left”, and “right” may be used herein to describe the relative placement and orientation of the features and components, each with respect to the geometry and orientation of other features and components appearing in the perspective, exploded perspective, and cross-sectional views provided herein. Said terminology is not intended to be limiting and includes the words specifically mentioned, derivatives therein, and words of similar import.

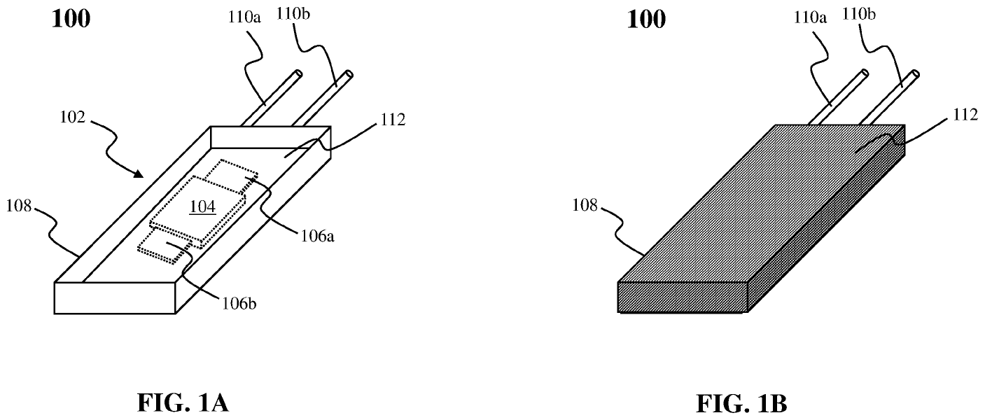

FIGS. 1A and 1B are representative drawings of a breaker assembly 100 for providing protection in high-temperature environments, according to exemplary embodiments. FIG. 1A is a perspective view of the breaker assembly 100 with the cover removed and FIG. 1B is a perspective view with the cover. As used herein, a high-temperature environment is one in which temperatures reach above 100° C. An automobile motor is one example of a high-temperature environment, as the temperature of the motor can reach greater than 100° C. In exemplary embodiments, the breaker assembly 100 can provide protection for electronic devices that reach up to 120° C.

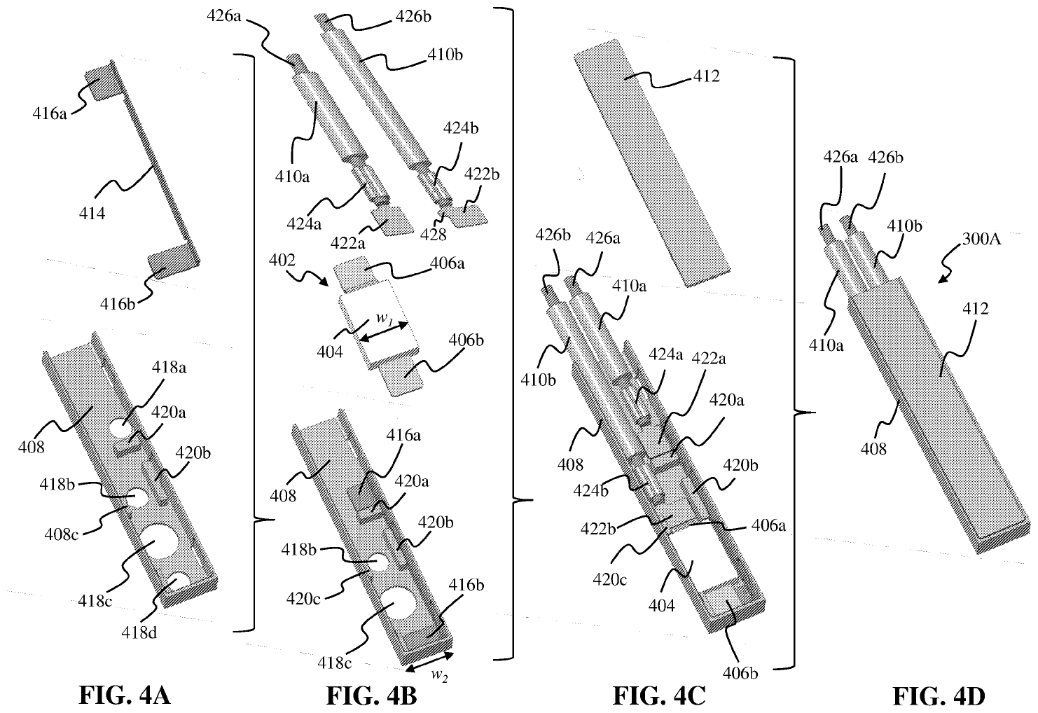

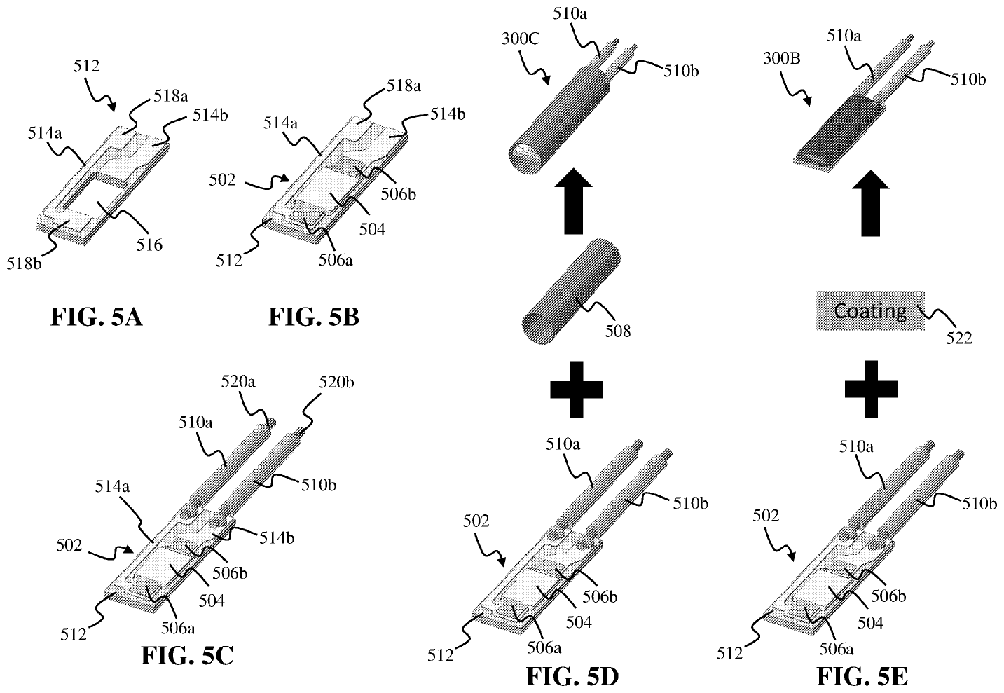

The breaker assembly 100 features a metal hybrid PPTC thermal cutoff mini-breaker 102 (hereinafter, “mini-breaker 102”) disposed within a housing 108 with a cover 112. Terminals 110a-b are shown extending from the housing 108 (collectively, “terminals 110”). The mini-breaker 102 includes a housing 104 and terminals 106a-b (collectively, “terminals 106”). In the simplified illustration of FIG. 1A, the cover 112 is transparent to show the mini-breaker 102 disposed within the housing 108, with connections between the terminals 106 of the mini-breaker 102 and the terminals 110 of the breaker assembly 100 not shown. The terminal couplings are shown and described in more detail in FIGS. 4A-4D and 5A-5E, below. In exemplary embodiments, the mini-breaker 102 is modified from legacy mini-breakers that support temperatures up to 100° C. By contrast, the mini-breaker 102 is able to protect electronic devices that reach up to 120° C. The breaker assembly 100 is thus able to be used in environments beyond protecting batteries for mobile devices. In exemplary embodiments, the breaker assembly 100 is used to protect motors for vehicles.

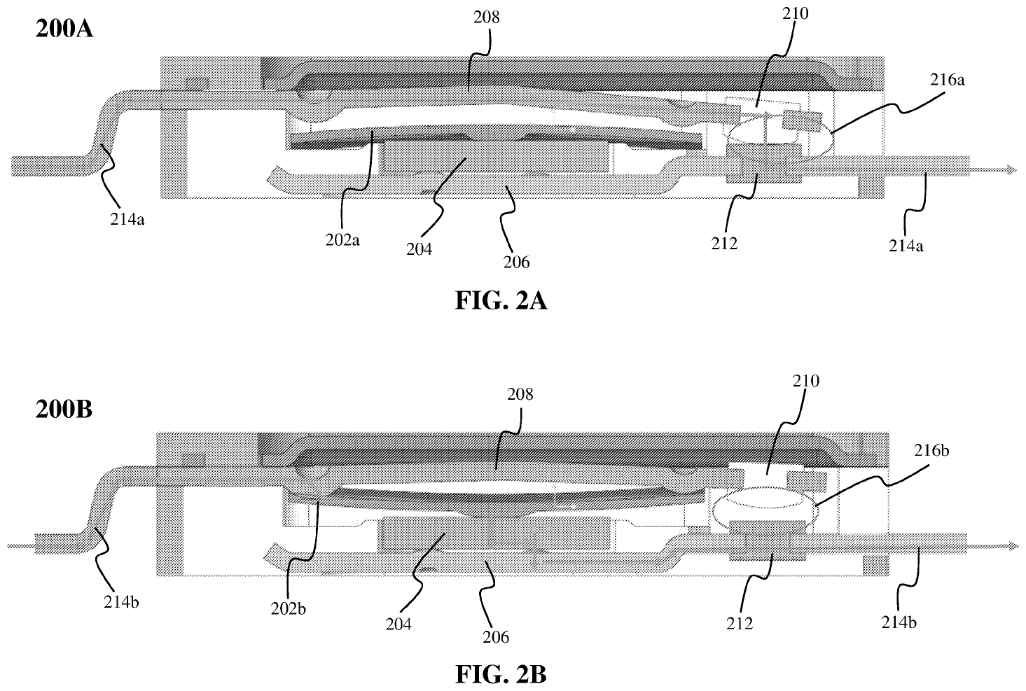

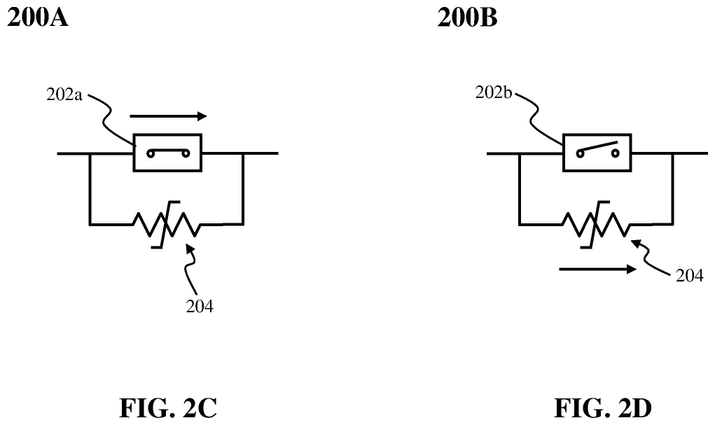

FIGS. 2A-2D are representative drawings of mini-breakers during both normal operation (e.g., no abnormal condition) and working operation (e.g., during abnormal condition, such as excessive temperature and/or overcurrent event), according to exemplary embodiments. FIG. 2A shows a mini-breaker 200A during normal operation; FIG. 2B shows the mini-breaker 200B during working operation; FIG. 2C shows the circuit diagram of the mini-breaker 200A during normal operation; and FIG. 2D shows the circuit diagram of the mini-breaker 200B during working condition (collectively, “mini-breaker 200”). The mini-breaker 200 consists of a bimetallic strip 202 and a polymeric positive temperature coefficient (PPPT) device 204. Bimetallic strip 202a (FIG. 2A) is in a first state while bimetallic strip 202b (FIG. 2B) is in a second state (collectively, “bimetallic strip 202”). The bimetallic strip 202 consists of two different types of metals, with the first metal having a first coefficient of thermal expansion and the second metal having a second, different coefficient of thermal expansion. In response to heat, the bimetallic strip 202 will bend, causing the bimetallic strip to change shape. In FIG. 2C, bimetallic strip 202a is shown in the closed position (normal operation), and in FIG. 2D, bimetallic strip 202b is shown in the open condition (working operation).

PPTC devices include material that changes its physical properties when heated up. Often used as a resettable fuse, the PPTC device quickly increases its resistance in response to a temperature increase resulting from sudden overcurrent or overheating. In the mini-breaker 200, the PPTC device 204 acts as a heater to keep the bimetallic strip 202 in a latched position until the temperature condition is removed.

As illustrated in FIG. 2A, the mini-breaker 200A features the bimetallic strip 202a and the PPTC device 204, as well as a base terminal 206, an arm terminal 208, an arm contact 210, and a base contact 212. A circled contact area 216a shows that, during the normal condition, the two contacts, the arm contact 210 and the base contact 212 are closed, that is, touching one another. A current path 214a shows that, during the normal condition, the current goes through the arm terminal 208, the arm contact 210, the base contact 212, and the base terminal 206. In the circuit diagram of the mini-breaker 200A (FIG. 2C), current is flowing through the bimetallic strip 202a and not flowing through the PPTC device 204, with the resistance of the bimetallic strip being much less than the resistance of the PPTC device.

As illustrated in FIG. 2B, the bimetallic strip 202b is bent differently than in FIG. 2A. A circled contact area 216b shows that, during the working condition, the bimetallic strip 202b flips over and lifts the arm terminal 208, such that the arm contact 210 is no longer connected to the base contact 212. A current path 214b shows that, during the working condition, the current goes through the arm terminal 208, the bimetallic strip 202b, the PPTC device 204, and the base terminal 206. Thus, when the contact area 216b opens, the current instead goes through the PPTC device 204, with the current heating up the PPTC device, and the resistance of the PPTC device increasing substantially, in some embodiments. In the circuit diagram of the mini-breaker 200B (FIG. 2D), current is flowing through the PPTC device 204 and not flowing through the bimetallic strip 202b.

Thus, the circuit of the mini-breaker 200A (FIG. 2C) shows that current is flowing through the bimetallic strip 202a while no current is flowing through the PPTC device 204, with the resistance of the bimetallic strip 202a being much lower than the resistance of the PPTC device. The circuit of the mini-breaker 200B (FIG. 2D) shows that in response to an overtemperature or overcurrent condition, the bimetallic strip 202b opens, the current then flows through the PPTC device 204, and the current heats up the PPTC device, which, being adjacent to the bimetallic strip 202b, keeps the bimetallic strip in a latched position until the abnormal condition is removed. By rerouting the current to the PPTC device which provides a very high resistance during the abnormal condition, the mini-breaker 200 protects the electronic device to which it is connected. The mini-breaker 200 characterized by the circuits of FIGS. 2C and 2D is designed to be resistance or laser-welded to the cell terminals of a battery, such as for a mobile device.

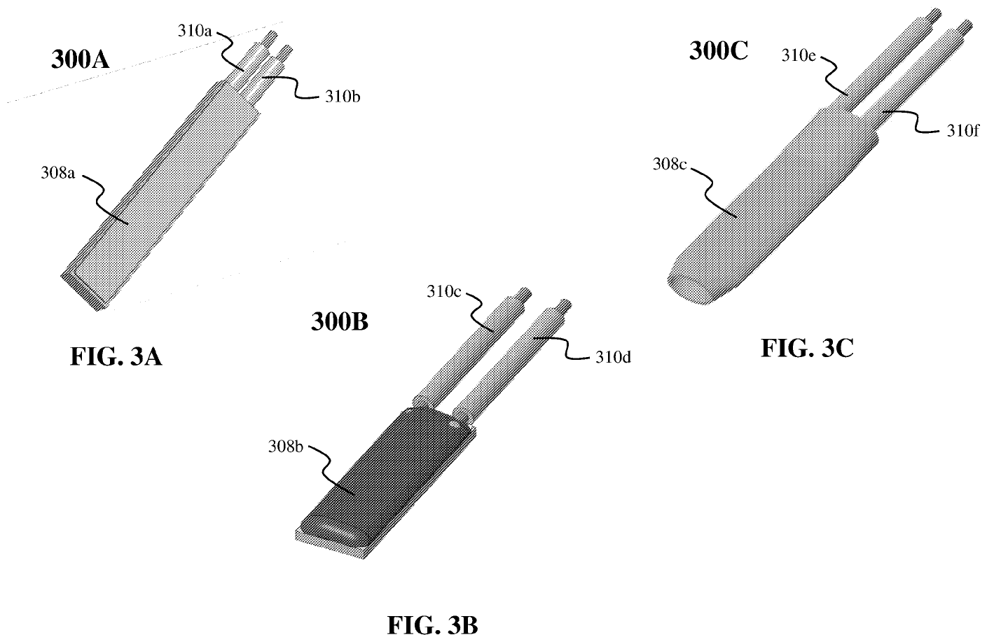

FIGS. 3A-3C are representative drawings of breaker assemblies, according to exemplary embodiments. FIG. 3A shows a breaker assembly 300A according to a first embodiment; FIG. 3B shows a breaker assembly 300B according to a second embodiment; and FIG. 3C shows a breaker assembly 300C according to a third embodiment (collectively, “breaker assembly 300” and “breaker assemblies 300”). In exemplary embodiments, like the breaker assembly 100, the breaker assemblies 300 utilize a mini-breaker that can provide protection for electronic devices, such as a vehicle motor, that can reach temperatures up to 120° C. The working temperature of a bimetallic switch depends on its shape. In one embodiment, the shape of the bimetallic strip of the breaker assembly 300 is modified from that of legacy mini-breakers to support the higher temperature, since legacy mini-breakers provide protection for electronic devices reaching up to 100° C.

Breaker assembly 300A includes a first housing 308a and terminals 310a and 310b; breaker assembly 300B includes a second housing 308b and terminals 310c and 310d; and breaker assembly 300C includes a third housing 308c and terminals 310e and 310f (collectively, “housing 308” and “terminals 310”). The breaker assembly 300A is shown in more detail in FIGS. 4A-4D and the breaker assemblies 300B and 300C are shown in more detail in FIGS. 5A-5E.

FIGS. 4A-4D are representative drawings showing construction of the breaker assembly 300A (FIG. 3A), according to exemplary embodiments. In FIG. 4A, a housing 408 and a lead extender 414 are shown. In exemplary embodiments, the housing 408 includes four openings 418a-d and three ledges 420a-c (collectively, “openings 418” and “ledges 420”). In exemplary embodiments, the housing 408 is made from a non-conductive material such as plastic. The lead extender 414 includes two ends 416a and 416b (collectively, “ends 416”).

In FIG. 4B, the lead extender 414 is shown inserted in the housing 408. A mini-breaker 402 and two terminals 410a and 410b are also shown (collectively, “terminals 410”). In exemplary embodiments, the lead extender 414 is positioned so that the end 416a is disposed on a side and adjacent to ledge 420a, with the end 416a covering the opening 418a. The middle portion of the lead extender 414 is positioned between the ledge 420b and the wall of the housing 408. The end 416b of the lead extender 414 is positioned over the opening 418d and is adjacent the end of the housing 408. In exemplary embodiments, once the lead extender 414 is in place in the housing 408, openings 418a and 418d are covered.

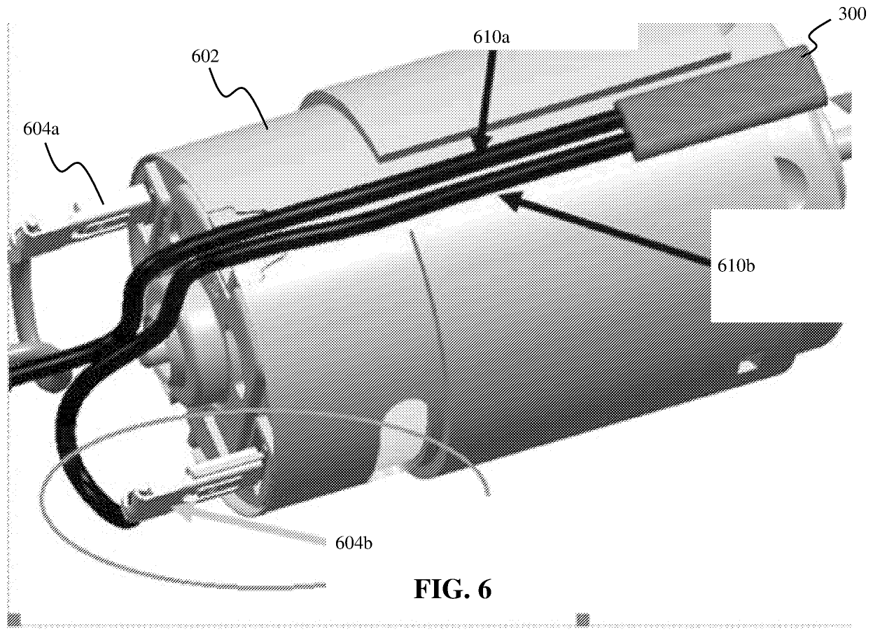

As with the mini-breaker 102 (FIG. 1A), the mini-breaker 402 has a housing 404 and two terminals 406a and 406b (collectively, “terminals 406”). The terminals 410 of the breaker assembly 300A include leads, extenders, and wires, with terminal 410a having lead 422a, extender 424a, and wire 426a and terminal 410b having lead 422b, extender 424b, and wire 426b (collectively, “leads 422”, “extenders 424”, and “wires 426”). With the help of the lead extender 414, the leads 422 establish a connection with respective terminals 406 of the mini-breaker 402. The wires 426 are for connection of the breaker assembly 300a to the circuit/device being protected, such as a vehicle motor (see, e.g., FIG. 6).

In exemplary embodiments, the terminal 410a is different from the terminal 410b, with terminal 410b being slightly longer than terminal 410a. Further, the shape of the leads 422 are different. Lead 422a is substantially rectangular in shape and is centered in connection to the extender 424a while lead 422b is rectangular in shape but includes an additional edge 428. Further, the lead 422b is not centered in connection to the extender 424b but is shifted off-center to connect to the extender 424b. As shown in FIG. 4C, the differences between the terminal 410a and the terminal 410b accommodate the shape of the housing 408, in exemplary embodiments.

In FIG. 4C, the mini-breaker 402 is inserted into the housing 408, with the terminal 406a being disposed over the opening 418b and the housing 404 being disposed over the opening 418c. Further, the terminal 406b of the mini-breaker 402 is positioned over the end 416b of lead extender 414 and the terminal 406a is disposed between the ledges 420b and 420c. In exemplary embodiments, the housing 404 of the mini-breaker 402 is disposed over the opening 418c. The opening 418c thus ensures that, once the breaker assembly 300A is positioned in place against the electronic component being protected (e.g., vehicle motor), the mini-breaker 402 will be proximate the electronic component and thus able to detect and quickly respond to an overtemperature condition of the electronic component.

Next, the terminals 410 are placed within the housing 408. The terminal 410b, the longer of the two terminals, is placed on one side of the housing 408 so that the lead 422b is positioned over the terminal 406a of the mini-breaker 402. The lead 422b is also disposed between the ledges 420b and 420c of the housing 408, with the edge 428 of the lead being disposed adjacent both the ledge 420c and the side of the housing. Terminal 410a is placed on the other side of the housing 408 so that the lead 422a is positioned over the end 416a of lead extender 414. The lead 422a is also adjacent both the ledge 420a and the wall of the housing 408. Once in place, the terminal 410a is parallel to the terminal 410b, with some portion of each terminal being disposed outside the housing and the wires 426a and 426b being adjacent one another.

In exemplary embodiments, the lead extender 414 is laser welded or resistance welded to the housing 408 of the breaker assembly 300A. The openings 418a and 418d facilitate the welding of the lead extender 414. Further, in exemplary embodiments, the terminals 406 of the mini-breaker 402 are affixed to the housing 408 using laser welding or resistance welding, with the opening 418b facilitating the welding of the terminal 406a and the terminal 406b being welded to the end 416b of the lead extender 414. Further, in exemplary embodiments, the leads 422 of the terminals 410 are also affixed to the housing 408 using laser welding or resistance welding, with the lead 422a being welded to the end 416a of the lead extender 414 and the lead 422b being welded to the terminal 406a of the mini-breaker 402.

As shown in FIG. 4B, the mini-breaker 402 has a width, w₁, while the housing 408 has a second width, w₂. In exemplary embodiments, the housing 408 is only slightly wider than the width of the mini-breaker 402. So, while w₂>w₁, the breaker assembly 300A is designed so that the width, w₂ is close to the width, w₁, since only the lead extender 414 is positioned next to the mini-breaker 402. Further, the side of the lead extender 414 between the two ends 416 is quite thin, in some embodiments. It is because of the arrangement of the mini-breaker 402 at one end of the housing 408 and the two terminals 410 at the other end of the housing that the lead extender 414 is used. The breaker assembly 300A thus employs the space of the housing economically.

In exemplary embodiments, the terminals 406, the leads 422, and the lead extender 414 are made of an electrically conductive materials, such as copper. The lead 422b of the terminal 410b is connected with the terminal 406a of the mini-breaker 402, which allows an electrical current to flow through the wire 426b of the terminal 410b and to the lead 422b, reaching the terminal 406a of the mini-breaker 402, and vice-versa. Further, in exemplary embodiments, the lead extender 414 causes a connection between the terminal 406b of the mini-breaker 402 and the lead 422a of the terminal 410a to be made, which allows an electrical current to flow through the wire 426a of the terminal 410a and to the lead 422a, reaching the terminal 406b of the mini-breaker 402, and vice-versa. Thus, the arrangement of the lead extender 414, the mini-breaker 402, and the terminals 410 within the housing 408 enables a current path to be formed.

Once the terminals 410 have been installed in the housing 408, the end 416a of the lead extender 414 and the lead 422a of the terminal 410a are disposed over the opening 418a; the terminal 406a of the mini-breaker 402 and the lead 422b of the terminal 410b are disposed over the opening 418b, and the end 416b of the lead extender 414 and the terminal 406b of the mini-breaker 402 are disposed over the opening 418d.

In FIG. 4D, a cover 412 is attached to the housing 408, thus encapsulating the lead extender, mini-breaker 402, and partially covering the terminals 410. The cover 412 and the housing 408 thus form an enclosure for the mini-breaker 402. In exemplary embodiments, the cover 412, like the housing 408, is made of a non-conductive material such as plastic. The wires 426 of the terminals 410 are able to be connected to terminals of an electronic device, such as a vehicle motor. The assembly of the breaker assembly 300A is thus complete.

FIGS. 5A-5E are representative drawings showing construction of the breaker assemblies 300B (FIG. 3B) and 300C (FIG. 3C), according to exemplary embodiments. FIGS. 5A-5C show the initial construction of the breaker assemblies 300B and 300C; FIG. 5D shows the completion of the breaker assembly 300C; and FIG. 5E shows the completion of the breaker assembly 300B. Except for the coating covering for breaker assembly 300B and the shrink wrap covering for the breaker assembly 300A, the two breaker assemblies 300B and 300C are constructed using the same materials. In contrast to the breaker assembly 300A (FIG. 3A and FIGS. 4A-4D), the breaker assemblies 300B and 300C utilize a printed circuit board rather than a housing to hold the mini-breaker.

FIG. 5A shows a printed circuit board (PCB) 512 including an opening 516 and two traces 514a and 514b (collectively, “traces 514”). In exemplary embodiments, the opening 516 is cut entirely through the PCB 512 and is sized to fit a housing 504 of a mini-breaker 502 (FIG. 5B). Accordingly, the opening 516 is substantially rectangular in shape, as is the housing 504 of the mini-breaker 502. The opening 516 thus ensures that, once the breaker assembly 300B or 300C is positioned in place against the electronic component being protected (e.g., vehicle motor), the mini-breaker 502 will be proximate the electronic component and thus able to detect and quickly respond to an overtemperature condition of the electronic component.

In exemplary embodiments, the traces 514 are dissimilar to one another, with trace 514b being disposed between a first end of the PCB 512 and a near side of the opening 516 while trace 514a is disposed between the first end and a far side of the opening. Similar to the lead extender 414 (FIG. 4A), the trace 514a includes ends 518a and 518b. The trace 514a is also longer than the trace 514b. The traces 514 are sized to accommodate the size of the terminals 506 of the mini-breaker 502. In FIG. 5B, the mini-breaker 502 is disposed on the PCB 512, with the housing 504 of the mini-breaker fitting into the opening 516. The terminal 506b of the mini-breaker 502 fits over the trace 514b near the opening 516 while the terminal 506a fits over the end 518b of the trace 514a (collectively, “terminals 506”). The traces 514 and the terminals 506 are made from electrically conductive materials, such as copper. Thus, the traces 514 form an electrical pathway to the respective terminals 506.

FIG. 5C shows terminals 510a and 510b of the breaker assembly 300B/300C (collectively, “terminals 510”). The terminals 510 are the same size, with terminal 510a including wire 520a and terminal 510b including wire 520b (collectively, “wires 520”). Terminal 510a is connected to trace 514a while terminal 510b is connected to trace 514b. In exemplary embodiments, these connections are made by soldering operations. Once connected, an electrical pathway through wire 520a of terminal 510a to trace 514a, then to terminal 506a, through housing 504, and to terminal 506b of mini-breaker 502, then to trace 514b, and through wire 520b of terminal 510b, and vice-versa, is established.

FIG. 5D shows the completion operations for constructing the breaker assembly 300C, according to exemplary embodiments. In exemplary embodiments, terminal 510a is welded to the end 518a of trace 514a and terminal 510b is welded to the trace 514b. The mini-breaker 502 is welded to the PCB 512 using a solder or reflow operation, with the terminal 506a being affixed to trace 514a and the terminal 506b being affixed to trace 514b. Once the PCB 512 has been populated with the mini-breaker 502 and the terminals 510, a shrink-wrap cover 508 is disposed over the PCB, with the terminals 510 being substantially outside the shrink-wrap cover but connected to respective traces 514 of the PCB. In exemplary embodiments, the shrink-wrap cover 508 is heated up and shrinks around the components of the breaker assembly 300C, such that the shrink wrap is disposed over and packages the mini-breaker 502 and surrounds the PCB 512, with the completed breaker assembly being illustrated in FIG. 3C. In exemplary embodiments, the shrink-wrap cover 508 is thin enough that, once the breaker assembly 300C is placed against the electronic component to be protected, the mini-breaker 502 will nevertheless be adjacent the electronic component and able to respond to an overtemperature event.

FIG. 5E shows the completion operations for constructing the breaker assembly 300B, according to exemplary embodiments. Once the PCB 512 has been populated with the mini-breaker 502 and the terminals 510, a coating covering 522 is disposed over the PCB, with the terminals 510 being substantially outside the coating covering but connected to respective traces 514 of the PCB. For example, the portion of the breaker assembly 300B shown in FIG. 5C may be dipped into a non-conductive, quick-drying epoxy, resin, or thermoplastic material to form the coating covering 522, which is disposed over and packages the mini-breaker 502 and surrounds the PCB 512. In exemplary embodiments, the coating covering 522 is thin enough that, once the breaker assembly 300B is placed against the electronic component to be protected, the mini-breaker 502 will nevertheless be adjacent the electronic component and able to respond to an overtemperature event.

FIG. 6 is a representative drawing of a vehicle motor utilizing one of the breaker assemblies 300, according to exemplary embodiments. A vehicle motor 602 is shown with the breaker assembly 300 being disposed adjacent the housing of the motor. Terminals 610a and 610b extend from the breaker assembly (collectively, “terminals 610”). The vehicle motor 602 also has terminals 604a and 604b (collectively, “terminals 604”), with terminal 610a connecting to terminal 604a and terminal 610b connecting to terminal 604b. In exemplary embodiments, the breaker assembly 300 is capable of providing protection to the vehicle motor 602 if the motor reaches up to 120° C. As shown in FIG. 2B, above, the mini-breaker within the breaker assembly 300 forms an open circuit in response to the overtemperature or overcurrent event.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. A breaker assembly comprising:
a first terminal comprising a first lead;
a second terminal comprising a second lead, wherein the second terminal is longer than the first terminal;
a mini-breaker comprising a third terminal and a fourth terminal; and
a housing, wherein the first terminal, the second terminal, and the mini-breaker are placed in the housing, with the first terminal being adjacent and parallel to the second terminal;
wherein the first lead is coupled to the fourth terminal in the housing and the second lead is disposed over the third terminal.

2. The breaker assembly of claim 1, wherein the first terminal and the second terminal are to be coupled to an electronic device.

3. The breaker assembly of claim 2, the mini-breaker further comprising a polymeric positive temperature coefficient (PPTC) device.

4. The breaker assembly of claim 3, wherein the PPTC device protects the electronic device in response to an overtemperature event.

5. The breaker assembly of claim 1, further comprising a lead extender to be disposed within the housing, wherein the mini-breaker is placed over the lead extender in the housing, the lead extender comprising a first end and a second end.

6. The breaker assembly of claim 5, wherein the first end is disposed beneath the first lead within the housing.

7. The breaker assembly of claim 5, wherein the second end is disposed beneath the second terminal within the housing.

8. The breaker assembly of claim 6, wherein the lead extender enables the first lead to be coupled to the fourth terminal.

9. The breaker assembly of claim 1, further comprising a cover to be attached to the housing, wherein the cover and the housing form an enclosure for the mini-breaker.

10. The breaker assembly of claim 2, the housing further comprising an opening, wherein the mini-breaker is adjacent the opening.

11. The breaker assembly of claim 5, the housing further comprising a ledge, wherein the first end of the lead extender is adjacent the ledge.

12. The breaker assembly of claim 5, wherein the lead extender is electrically conductive.

13. A breaker assembly comprising:
a printed circuit board (PCB) comprising a first trace, a second trace, and an opening, wherein the first trace is longer than the second trace;
a first terminal coupled to the first trace;
a second terminal coupled to the second trace; and
a mini-breaker comprising a third terminal, a fourth terminal, and a housing, the housing to fit into the opening, wherein the third terminal sits on the first trace and the fourth terminal sits on the second trace.

14. The breaker assembly of claim 13, wherein the first terminal and the second terminal are to be coupled to an electronic device.

15. The breaker assembly of claim 14, wherein the mini-breaker protects the electronic device from an overcurrent event.

16. The breaker assembly of claim 14, wherein the mini-breaker protects the electronic device from an overtemperature event.

17. The breaker assembly of claim 13, further comprising a covering disposed over the mini-breaker and surrounding the PCB.

18. The breaker assembly of claim 17, wherein the covering is a shrink-wrap cover.

19. The breaker assembly of claim 17, wherein the covering is non-conductive and quick-drying.

20. The breaker assembly of claim 14, wherein the mini-breaker protects the electronic device from temperatures up to 120° C.
